(19) United States
(12) Patent Application Publication
(10) Pub. No.: US 2013/0207461 A1
(43) Pub. Date: Aug. 15, 2013

(54) HIGH-VOLTAGE BATTERY SYSTEM

(71) Applicant: SK INNOVATION CO., LTD., (US)

(72) Inventor: Geun Hoe HUH, Daejeon (KR)

(73) Assignee: SK INNOVATION CO., LTD., Seoul (KR)

(21) Appl. No.: 13/756,843

(22) Filed: Feb. 1, 2013

(30) Foreign Application Priority Data
Feb. 9, 2012 (KR) 10-2012-0013379

(51) Int. Cl. B60R 16/03

(52) U.S. Cl. CPC B60R 16/03
USPC 307/10.1

(57) ABSTRACT

Provided is a high-voltage battery system, including a battery pack, a relay part, a relay control part, and a low pass filter part, so that the low pass filter part receives a relay control signal outputted from an output terminal of the relay control part and removes noise therefrom, to thereby remove fundamental causes of fusion of a relay.

### CROSS-REFERENCE TO RELATED APPLICATIONS

This application claims priority under 35 U.S.C. §119 to Korean Patent Application No. 10-2012-0013379, filed on Feb. 9, 2012, in the Korean Intellectual Property Office, the disclosure of which is incorporated herein by reference in its entirety.

### TECHNICAL FIELD

The following disclosure relates to a high-voltage battery system, and more particular, to a high-voltage battery system capable of removing chattering and noise by using a low pass filter and a Schmitt trigger at a relay control signal output terminal of a relay control part.

### BACKGROUND

A hybrid vehicle in a broad sense generally means a vehicle that is driven by efficiently combining two or more different kinds of power sources. However, in most cases, a vehicle that is driven by an engine obtaining torque resulting from combustion of fuel (chemical fuel such as gasoline or the like) and an electric motor obtaining torque from a battery power, which is commonly called a hybrid electric vehicle (HEV).

This hybrid vehicle is a future vehicle that can promote improvement in fuel mileage and reduction in exhaust gas by employing an engine as well as an electric motor as an auxiliary power source, and has been more actively studied to meet the demands of the times that fuel mileage should be improved and eco-friendly products should be developed.

The hybrid vehicle may be constituted in various structures by using engines and electric motors as a power source, and has been widely adopted as a car and the like due to its advantage that mechanical energy of the engine and electric energy of the battery are simultaneously used to thereby allow efficient use of energy.

Korean Patent Laid-Open Publication No, 10-2010-0064068 (entitled: “Short Preventing Method for Relay”, hereinafter, referred to as Related Art 1) relates to a short preventing method of relay contact, and discloses that, when any controller is to request an OFF state of a main relay to a BMS, operations related, to the other controllers that do not request an OFF state of the main relay to the BMS are stopped before any controller transmits a signal for the request for the OFF state of the main relay, and thus, the main relay can be prevented from being fused.

As such, the related art discloses various methods for preventing fusion of a relay.

The present invention suppresses chattering and, noise of a relay control signal, which are main causes of fusion of a relay in a high-voltage battery pack, by using a low pass filter and a Schmitt trigger, thereby preventing the fusion of the relay.

### RELATED ART DOCUMENT

### Patent Document

(Patent Document 1) Korean Patent Laid-Open Publication No. 2010-0004567

### SUMMARY

An embodiment of the present invention is directed to providing a high-voltage battery system capable of suppressing chattering and noise of a relay control signal, which are main causes of fusion of a relay in a high-voltage battery pack, by using a low pass filter and a Schmitt trigger, thereby preventing fusion of a relay.

In one general aspect, a high-voltage battery system includes: a battery pack having a positive electrode terminal and a negative electrode terminal; a relay part including a first main relay connected in series with the positive electrode terminal of the battery pack, a second main relay connected in series with the negative electrode terminal of the battery pack, and a pre-charge relay connected in parallel with the first main relay, and a pre-charge resistor connected in series with the pre-charge relay; a relay control part controlling the relay part; and a low pass filter part having one end connected in series with an output terminal of the relay control part and the other end connected in series with each relay coil of the relay part, the low pass filter part primarily removing noise included in a relay control signal outputted from, the relay control part.

The high-voltage battery system may further include a Schmitt trigger part connected in series with an output terminal of the low pass filter to receive and process the relay control signal passing through the low pass filter.

The low pass filter part may use an RC circuit.

The low pass filter part may include: a resistor having one end connected to an output terminal of the relay control part and the other end connected to a first node; and a capacitor having one end connected to the first node and the other end connected to a ground.

The low pass filter part may use an OP-AMP circuit.

### BRIEF DESCRIPTION OF THE DRAWINGS

FIG. 1 is a circuit diagram showing a configuration of a high-voltage battery system, according to an embodiment of the present invention;

FIG. 2 is a circuit diagram showing a configuration of a low pass filter part according to the embodiment of the present invention;

FIG. 3 is a diagram showing a waveform of a relay signal outputted from a relay circuit according to the embodiment of the present invention;

FIG. 4 is a diagram showing a waveform of the relay signal passing through the low pass filter part according to the embodiment of the present invention; and

FIG. 5 is a diagram showing a waveform of the relay signal passing through a Schmitt trigger part according to the embodiment of the present invention.

[Detailed Description of Main Elements]

| | |
|---|---|
| 100: battery pack | 300: relay part |
| 310: first main relay | 320: second main relay |
| 330: pre-charge relay | 340: pre-charge resistor |
| 400: low pass filter | 410: resistor |
| 420: capacitor | 430: ground |
| 500: Schmitt trigger part | 510: Schmitt trigger |

### DETAILED DESCRIPTION OF EMBODIMENTS

Hereinafter, embodiments of the present invention will be described with reference to the accompanying drawings.

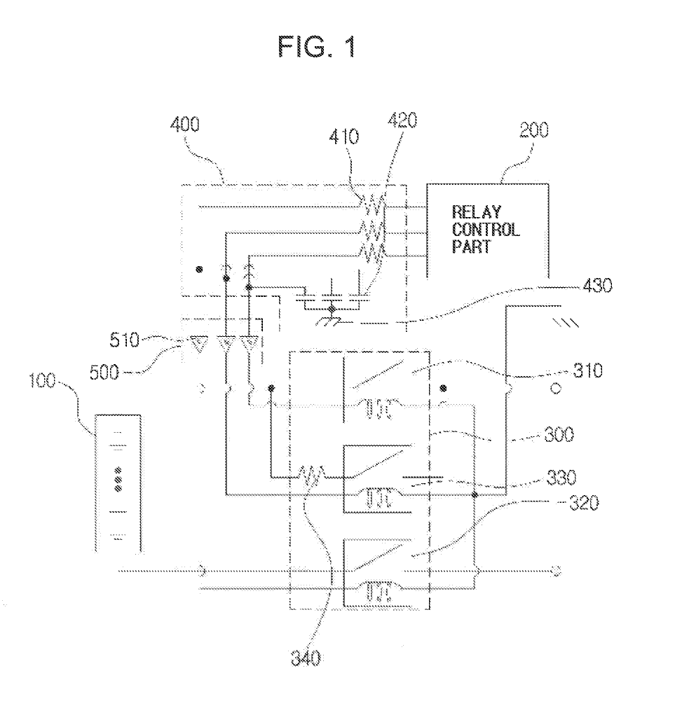

FIG. 1 is a circuit diagram showing a configuration of a high-voltage battery system according to an embodiment of the present invention. As shown in FIG. 1, a high-voltage battery system according to an embodiment of the present invention may include a battery pack 100, a relay control part 200, a relay part 300, and a low pass filter part 400.

The batty pack 100 may include a positive electrode terminal and a negative electrode terminal. The battery pack 100 of the high-voltage battery system according to the embodiment of the present invention is preferably a high-voltage battery for a hybrid vehicle.

The relay part 300 may include a first main relay 310 connected in series with the positive electrode terminal of the battery pack 100, a second main relay 320 connected in series with the negative electrode terminal of the battery pack 100, a pre-charge relay 330 connected in parallel with the first main relay 310, and a pre-charge resistor 340 connected in series with the pre-charge relay 330. The pre-charge relay 330 and the pre-charge resistor 340 are connected in series with each other to constitute a pre-charge circuit. The pre-charge relay 330 is allowed to be pre-charged before current outputted from the battery is connected to the first main relay 310. This prevents arc discharge that may occur at the time when the current is directly connected, to the first main relay 310, so that stability in circuit can be secured. Here, it is preferable that the pre-charge relay 330 is connected, in parallel with the first main relay 310.

The relay control part 200 controls the relay part 300.

The hybrid vehicle has a configuration where an electric motor is driven by power from a DC source such, as a secondary battery or the like. In this case, the electric motor is rarely directly driven by power from the DC source. The power from the DC source is supplied, to an inverter, and the inverter is allowed, to generate AC power or DC power to be supplied, to the electric motor. By using the inverter and by switching control in the inverter, the RPM or output torque of the electric motor may be controlled. In the case of the hybrid vehicle, for example, the battery pack 100 of a lithium ion secondary battery may used as a DC source, and the voltage between terminals of the battery pack 100 may be for example 288V.

As for the hybrid vehicle, DC power allowing a voltage of 170V or higher and a large current is employed, and thus relay contacts are inserted in respective positive and negative side power lines of the DC power, for security, electric stability, and the like. When DC power is not used, DC power is completely separated from a load circuit such as an inverter or the like. In addition, as for driving of the electric motor, a variation in load is remarkable, resulting in a large variation in input voltage to the load circuit such as an inverter, and thus, in order to reduce the variation, a smoothing large-capacitance capacitor is prepared between the positive and negative side power lines, at an input side of the load circuit.

Inrush current, flows on the capacitor when all the contacts of the first and second main relays 310 and 320 are electrically conducted, and thus the contacts of these main relay may be in danger of being fused, that is, fixed, if such fusion occurs, the relay contacts cannot shift back to a shut-off state, and thus a function as a relay may be lost. In this case, the power may not be completely separated from the load circuit such as the inverter, and thus there may be risks of injury to human body due to electric shock and fire accidents due to excessive reaction in the battery. Certainly, large inrush current may flow due to electric characteristics of the load circuit itself, to thereby fuse contacts of the relay, even though the capacitor is not particularly prepared.

Accordingly, a circuit where an overcurrent preventing circuit composed of the pre-charge resistor 340 and the pre-charge relay 330 connected, in series with each other is connected in parallel with the first, main relay 310 is prepared, so that the contacts of the relays can be prevented from being fused. That is, when the power is supplied to the load circuit at the shut off state, the relay control part 200 first allows the second main relay 320 at the negative side of the battery pack 100 to be an ON state, and then the pre-charge relay 330 to be an ON state. As a result, charge current flows into the capacitor through the pre-charge resistor 340 and then the capacitor is slowly charged. After that, the relay control part 200 allows the first main relay 310 at the positive side of the battery pack 100 to be an ON state and subsequently the pre-charge relay 330 to be an OFF state, so that the power can be supplied, from, the battery pack 100 to the load circuit through the first and second, main relays 310 and 320 without generating large inrush current.

As described above, the capacitor plays a buffer role by being appropriately charged, or discharged between the battery pack 100 and the load, circuit, in order to counteract the rapid change in power of the load.

According to the foregoing configuration, when the pre-charge relay 330 becomes first in an OK state by control of the relay control part 200, the capacitor is charged while peak current is restricted by the pre-charger resistor 340, and after, the first main relay 310 becomes in an ON state and the pre-charge relay 330 becomes in an OFF state, to thereby start charging and discharging.

FIG. 3 is a diagram showing a waveform of a relay signal outputted from a relay circuit according to the embodiment of the present invention.

As shown in FIG. 3, a relay signal outputted from the relay control part 200 has noise. An instantaneous unspecific pulse may be generated in a relay control signal from the relay control part 200, and this phenomenon is called chattering or bouncing. This phenomenon may cause a system to erroneously operate. Therefore, a circuit for preventing this phenomenon is necessary, and may be easily realized by using a low pass filter part 400 and a Schmitt trigger part 500 in the present invention.

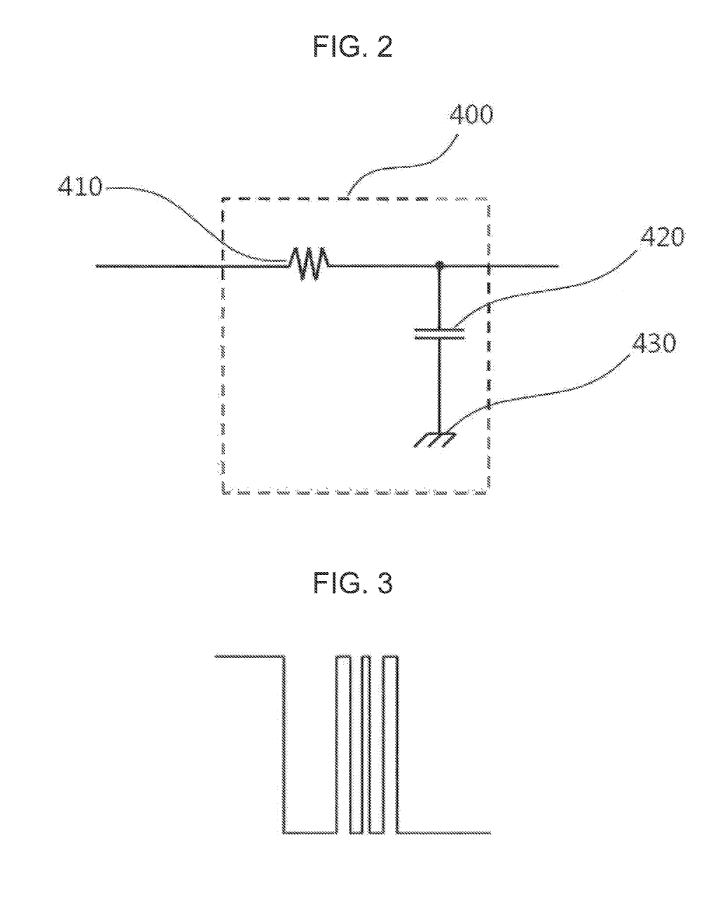

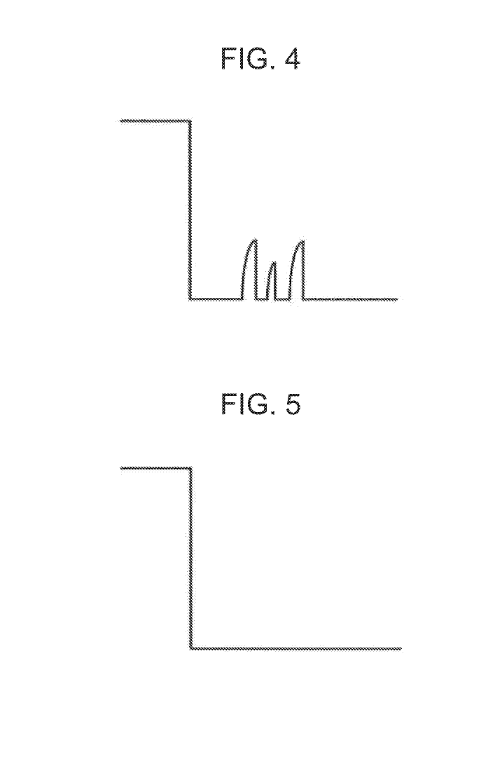

As shown in FIG. 1, one end of the low pass filter part 400 is connected in series to an output terminal of the relay control part 200 and the other end of the lower pass filter 400 is connected, in series to each relay coil of the relay 300. The low pass filter part 400 primarily removes noise included in a relay control signal outputted from the relay control part 200. The low pass filter part 400 may employ an RC circuit or an OP-AMP circuit. FIG. 2 is a circuit diagram showing a configuration of the low pass filter part 400 according to the embodiment of the present invention. As shown in FIG. 2, the low pass filter part 400 may include a resistor 410 and a capacitor 420. The resistor 410 may be connected in series between the relay control part 200 and the relay part 300. Here, one end of the capacitor 420 is connected between the resistor 410 and the relay part 300 and the other end of the capacitor 420 is connected to the ground 430, FIG. 4 is a diagram showing a waveform of the relay signal passing through the low pass filter part 400 according to the embodiment of the present invention.

The low pass filter part 400 is a circuit that removes a high frequency component from the relay signal as a main signal through grounding. The low pass filter part 400 is very advantageous in removing high-frequency noise included in the relay signal, as shown in FIG. 4.

The high-voltage battery system according to the embodiment of the present invention may further include the Schmitt trigger part 500. The Schmitt trigger part 500 is connected in series to an output terminal of the low pass filter part 400 to receive the relay signal passing the low pass filter part 400 and then secondarily remove noise included, in the relay control signal. The Schmitt trigger part 500 is a comparator having hysteresis. FIG. 5 is a diagram showing a waveform of the relay signal passing through the Schmitt trigger part 500 according to the embodiment of the present invention.

As shown in FIG. 5, Schmitt triggers 510 of the Schmitt trigger part 500 rapidly operate to obtain an almost constant output if the amplitude of the relay signal inputted from the low pass filter part 400 exceeds a predetermined level, and perform a direct recovery operation if the amplitude thereof is no larger than the predetermined level.

The Schmitt trigger part 500 is a circuit that converts an output from a high state to a low state if an input voltage is no lower than the raising trigger level voltage, and converts the output from a low state to a high state if an input voltage is no higher than the falling trigger level voltage. Therefore, when any sine wave or triangular wave, instead of a square wave, is applied, there can be obtained a square wave having a pulse width of a corresponding trigger level.

As such, according to the high-voltage battery system of the present invention, the low pass filter and the Schmitt trigger are used to suppress chattering and noise of the relay control, signal, which are main causes of fusion of the relay in the high-voltage battery pack 100, to thereby prevent fusion of the relay.

As set forth above, according to the high-voltage battery system of the present invention, the low pass filter and the Schmitt trigger are used to suppress chattering and noise of a relay control signal, which are main causes of fusion of the relay in the high-voltage battery pack, to thereby prevent fusion of the relay.

While the present invention has been shown and described in connection with the embodiments and drawings, the present invention is not limited to the foregoing embodiments, and it will foe apparent, to those skilled in the art that various modifications and variations can be made from, the descriptions. Accordingly, the spirit and scope of the present invention should be understood by only the appended claims, and all the equivalents or equivalent modifications thereof should be intended to fall within the scope of the present invention.

What is claimed is:

1. A high-voltage battery system, comprising:
a battery pack having a positive electrode terminal and a negative electrode terminal;
a relay part including a first main relay connected in series with the positive electrode terminal of the battery pack, a second main relay connected in series with the negative electrode terminal of the battery pack, and a pre-charge relay connected in parallel with the first main relay, and a pre-charge resistor connected in series with the pre-charge relay;
a relay control part controlling the relay part; and
a low pass filter part having one end connected in series with an output terminal of the relay control part and the other end connected in series with each relay coil of the relay part, the low pass filter part primarily removing noise included in a relay control signal outputted from the relay control part.

2. The high-voltage battery system of claim 1, further comprising a Schmitt trigger part connected in series with an output terminal of the low pass filter to secondarily remove noise included in the relay control signal passing through the low pass filter.

3. The high-voltage battery of claim 1, wherein the low pass filter part uses an RC circuit.

4. The high-voltage battery of claim 3, wherein the low pass filter part includes:
a resistor connected in series between the relay control part and the relay part; and
a capacitor having one end connected between the resistor and the relay part and the other end connected to a ground.

5. The high-voltage battery of claim 1, wherein the low pass filter part uses an OP-AMP circuit.
